(19) United States
(12) Patent Application Publication
(10) Pub. No.: US 2009/0003724 A1
(43) Pub. Date: Jan. 1, 2009

(54) Block noise reducer

(75) Inventors: Kengo Uratani, Tokyo (JP); Ryosuke Namiki, Tokyo (JP); Akihiro Nagase, Tokyo (JP); Hideki Yoshii, Tokyo (JP); Shuichi Kagawa, Tokyo (JP); Jun Someya, Tokyo (JP); Hiroaki Sugiura, Tokyo (JP)

Correspondence Address: BIRCH STEWART KOLASCH & BIRCH, PO BOX 747, FALLS CHURCH, VA, 22040-0747, US

(73) Assignee: Mitsubishi Electric Corporation, Tokyo (JP)

(21) Appl. No.: 12/155,844

(22) Filed: Jun. 10, 2008

(30) Foreign Application Priority Data
Jun. 11, 2007 (JP) 2007-153755

(51) Int. Cl. G06K 9/40

(52) U.S. Cl. 382/268

(57) ABSTRACT

A block noise reducer detects block boundaries in all components of an input video signal and smoothes the different components selectively on the basis of the detected block boundaries and their periodic locations. By removing block noise on the basis of block boundaries detected in color difference signals, the block noise reducer removes block noise from scenes with gradual changes in color but little or no change in luminance.

### BACKGROUND OF THE INVENTION

1. Field of the Invention

The present invention relates to video signal processing technology for reducing block noise that occurs when a digital video signal is decoded after being transmitted or recorded in a block-encoded form.

2. Description of the Related Art

Block coding is an effective method of compressing both still image and video data. When image data are compressed and decompressed by block coding, however, block noise (also called block distortion) tends to occur due to processing discontinuities at the block boundaries, because each block is encoded and decoded as a closed spatial unit. Detecting block noise and reducing it by appropriate filtering is a known art.

One known block noise reducer, disclosed in PCT Patent Application Publication No. WO2005-004489, employs an edge detector to detect edges in the luminance component of an input video signal, a bank of edge counters to count edges detected at different periodic locations, and a boundary identifier to identify block boundaries from the counts of detected edges. (See lines 1 to 37 on page 7 of the Japanese PCT publication, and FIGS. 1 and 2).

A problem with this known block noise reducer is that since it detects edges only in the luminance component, it fails to detect edges marked by changes in color rather than luminance. This leads to a failure to reduce block noise caused by the block encoding and decoding of the color difference signals in the chrominance component. For example, visible block noise tends to remain in sky and sunset scenes and other scenes with gradually changing colors.

### SUMMARY OF THE INVENTION

An object of the present invention is to remove block noise from scenes with gradual changes in color but little or no change in luminance.

A more general object is to remove block noise from different signal components selectively in an interrelated manner.

A block noise reducer according to the invention receives an input video signal including a plurality of signal components.

A plurality of block noise detectors detect block boundaries in respective signal components of the input video signal and output respective boundary detection signals and detected phase signals. The boundary detection signals indicate whether block boundaries are detected or not in each signal component. The detected phase signals indicate the periodic locations of the detected block boundaries.

A block phase comparator compares the boundary detection signals and detected phase signals and generates respective smoothing enable signals and smoothing phase signals. The smoothing enable signals indicate whether to smooth each of the signal components of the input video signal. The smoothing phase signals indicate periodic locations in each of the signal components.

A smoother smoothes the signal components indicated by the smoothing enable signals at the periodic locations indicated by the smoothing phase signals.

Because the block phase comparator examines the boundary detection signals and detected phase signals for all signal components and outputs respective smoothing enable signals and smoothing phase signals, the smoother can selectively smooth those signal components in which block noise is detected, and can use the information about all signal components in choosing the periodic locations at which to remove block noise in each signal component. In particular, the smoother can remove block noise on the basis of block boundaries detected in the chrominance component of the input video signal even when block boundaries are not detected in the luminance component because of a lack of luminance variation.

### BRIEF DESCRIPTION OF THE DRAWINGS

In the attached drawings:

FIG. 1 is a block diagram illustrating a block noise reducer embodying the invention;

FIG. 2 is a block diagram illustrating the luminance horizontal block boundary detector in the block noise reducer in FIG. 1;

FIG. 3 is a block diagram of the spatial difference comparator in the luminance horizontal block boundary detector in FIG. 2;

FIGS. 4A to 4C and 5A to 5C are timing diagrams illustrating the operation of the spatial difference comparator;

FIG. 6 is a block diagram of the phased accumulator in the luminance horizontal block boundary detector;

FIGS. 7A to 7J illustrate the operation of the phased accumulator;

FIG. 8 is a block diagram of the maximum sum and phase detector in the luminance horizontal block boundary detector;

FIG. 9 is a block diagram of the phase consistency tester in the luminance horizontal block boundary detector;

FIGS. 10A to 10L illustrate the operation of the phase consistency tester;

FIG. 11 is a block diagram of the luminance horizontal smoother in the block noise reducer; and

FIGS. 12A to 12E illustrate the operation of the luminance horizontal smoother.

### DETAILED DESCRIPTION OF THE INVENTION

An embodiment of the invention will now be described with reference to the attached drawings, in which like elements are indicated by like reference characters.

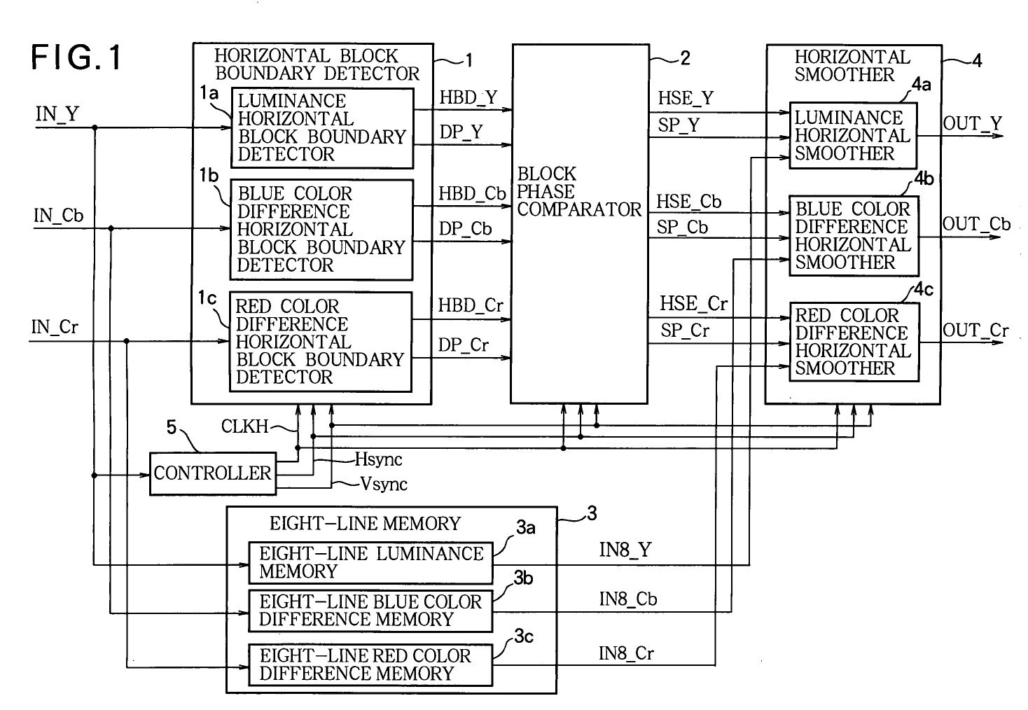

Referring to FIG. 1, the block noise reducer in the embodiment comprises a block noise detector referred to below as a horizontal block boundary detector 1, a block phase comparator 2, an eight-line memory 3, a horizontal smoother 4, and a controller 5.

The horizontal block boundary detector 1 detects edges occurring at intervals equal to the block width in an input luminance signal IN_Y, an input blue color difference signal IN_Cb, and an input red color difference signal IN_Cr. In the present embodiment, the block width is assumed to be eight pixels.

From the edge detection results over eight horizontal lines, the block phase comparator 2 obtains a smoothing phase signal and a smoothing enable signal for each of the three input signals IN_Y, IN_Cb, IN_Cr.

The eight-line memory 3 comprises an eight-line luminance memory 3a, an eight-line blue color difference memory 3b and an eight-line red color difference memory 3c, which delay the luminance signal IN_Y and color difference signals IN_Cb, IN_Cr by eight lines each to generate a delayed luminance signal INB_Y and delayed color difference signals IN8_Cb, IN8_Cr.

The horizontal smoother 4 comprises a luminance horizontal smoother 4a, a blue color difference horizontal smoother 4b, and a red color difference horizontal smoother 4c, which smooth the delayed luminance signal IN8_Y and the delayed color difference signals IN8_Cb, INB_Cr according to the smoothing phase signals and smoothing enable signals output by the block phase comparator 2.

The controller 5 generates a horizontal synchronizing signal Hsync, a vertical synchronizing signal Vsync, and a pixel clock CLKH from the input luminance signal IN_Y, and outputs CLKH, Hsync, and Vsync to the horizontal block boundary detector 1, the block phase comparator 2, and the horizontal smoother 4 as control signals.

The horizontal block boundary detector 1 comprises a luminance horizontal block boundary detector 1a, a blue color difference horizontal block boundary detector 1b, and a red color difference horizontal block boundary detector lc.

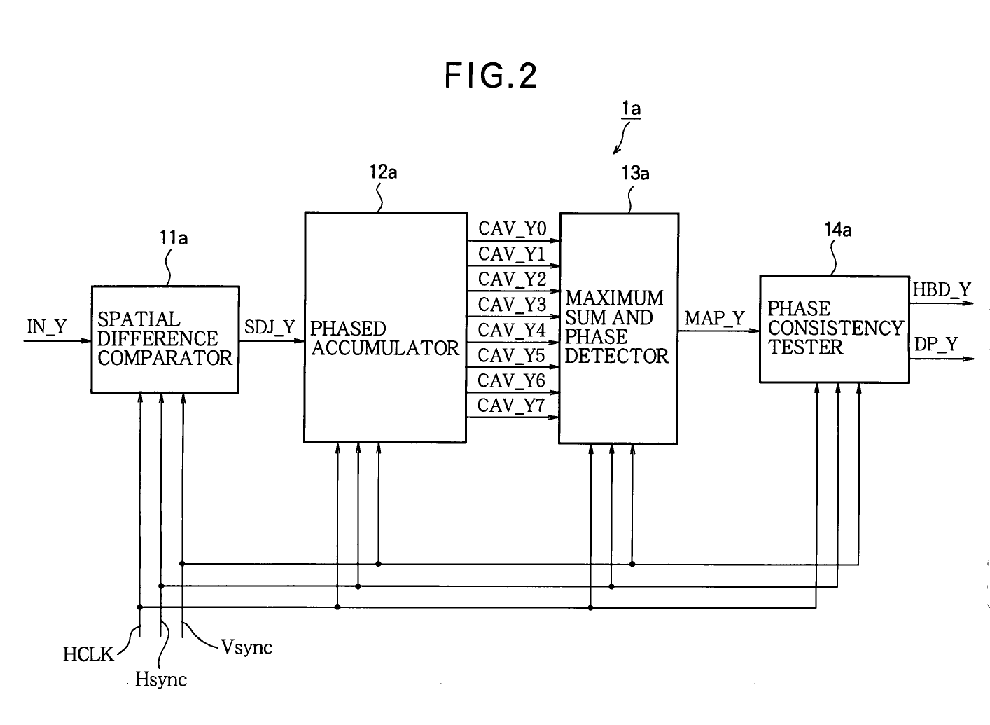

Referring to FIG. 2, the luminance horizontal block boundary detector 1a comprises a spatial difference comparator 11a that detects edges in the luminance signal IN_Y, a phased accumulator 12a that includes eight counters and counts edges detected at eight different periodic locations (referred to below as phases) in the block width, a maximum sum and phase detector 13a that indicates a phase at which a maximum value among the count values occurs, and a phase consistency tester 14a that stores these phase values for eight lines, compares the eight stored phase values, and indicates the phase if the phase values are identical.

A more detailed description of these operations will be given below with reference to FIGS. 1 and 2.

In FIG. 1, the luminance horizontal block boundary detector 1a receives the input luminance signal IN_Y, detects block boundaries in the input luminance signal IN_Y, generates a horizontal boundary detection signal HBD_Y that indicates whether block boundaries are detected and a detected phase signal DP_Y that indicates the periodic locations of the detected block boundaries, and outputs the horizontal boundary detection signal HBD_Y and the detected phase signal DP_Y to the block phase comparator 2.

The blue color difference horizontal block boundary detector 1b has the same internal structure as the luminance horizontal block boundary detector 1a but receives the blue color difference signal IN_Cb, instead of the luminance signal IN_Y, as an input signal. The blue color difference horizontal block boundary detector 1b performs the same operations on the input blue color difference signal IN_Cb as the luminance horizontal block boundary detector 1a performs on the input luminance signal IN_Y, generates a horizontal boundary detection signal HBD_Cb and a detected phase signal DP_Cb, and outputs HBD_Cb and DP_Cb to the block phase comparator 2.

The red color difference horizontal block boundary detector 1c has the same internal structure as the luminance horizontal block boundary detector 1a but receives the red color difference signal IN_Cr instead of the luminance signal IN_Y as an input signal. The red color difference horizontal block boundary detector 1c performs the same operations on the input red color difference signal IN_Cr as the luminance horizontal block boundary detector 1a performs on the input luminance signal IN_Y, generates a horizontal boundary detection signal HBD_Cr and a detected phase signal DP_Cr, and outputs HBD_Cr and DP_Cr to the block phase comparator 2.

When the input luminance signal IN_Y, the input blue color difference signal IN_Cb, and the input red color difference signal IN_Cr are supplied to the horizontal block boundary detector 1, the controller 5 extracts a horizontal synchronizing signal Hsync and a vertical synchronizing signal Vsync from the input luminance signal IN_Y, and supplies Hsync and Vsync to the horizontal block boundary detector 1, the block phase comparator 2, and the horizontal smoother 4.

The controller 5 also generates a pixel clock CLKH with a period equal to the pixel sampling period, synchronized to the horizontal synchronizing signal Hsync, and supplies CLKH to the horizontal block boundary detector 1, the block phase comparator 2, and the horizontal smoother 4.

In the horizontal block boundary detector 1, the horizontal synchronizing signal Hsync, the vertical synchronizing signal Vsync, and the pixel clock CLKH are supplied to the spatial difference comparator 11a, the phased accumulator 12a, the maximum sum and phase detector 13a, and the phase consistency tester 14a in the luminance horizontal block boundary detector 1a, and to the corresponding elements in the blue color difference horizontal block boundary detector 1b and the red color difference horizontal block boundary detector 1c.

The spatial difference comparator 11a in FIG. 2 calculates differences between the values of adjacent pixels in the input luminance signal IN_Y, outputs the calculated differences as spatial differences, detects edges by comparing the calculated spatial differences, and outputs the results to the phased accumulator 12a as a decision signal SDJ_Y indicating, for each calculated spatial difference, whether an edge is detected at a corresponding position.

The phased accumulator 12a includes eight counters that cyclically receive the decision signal SDJ_Y, count edges detected at the eight different periodic locations or phases in the receiving cycle (the length of the receiving cycle is eight pixel clock periods, equivalent to the horizontal block width), and generate results for one line of pixels as eight count values CAV_Y0 to CAV_Y7 corresponding to the eight different phases. These count values are supplied to the maximum sum and phase detector 13a at a timing synchronized with the horizontal synchronizing signal Hsync extracted from the input luminance signal IN_Y.

For each line of pixels, the maximum sum and phase detector 13a generates a maximum phase signal MAP_Y indicating the phase at which a maximum value among the eight count values CAV_Y0 to CAV_Y7 occurs and outputs MAP_Y to the phase consistency tester 14a. The detected block phase signal DP_Y is output once per line.

The phase consistency tester 14a stores the maximum phase signal MAP_Y for eight consecutive lines, compares the eight stored values, decides whether the eight MAP_Y values are identical, outputs the result as a horizontal boundary detection signal HBD_Y, and outputs the maximum phase signal MAP_Y as the detected phase signal DP_Y if the eight MAP_Y values are identical.

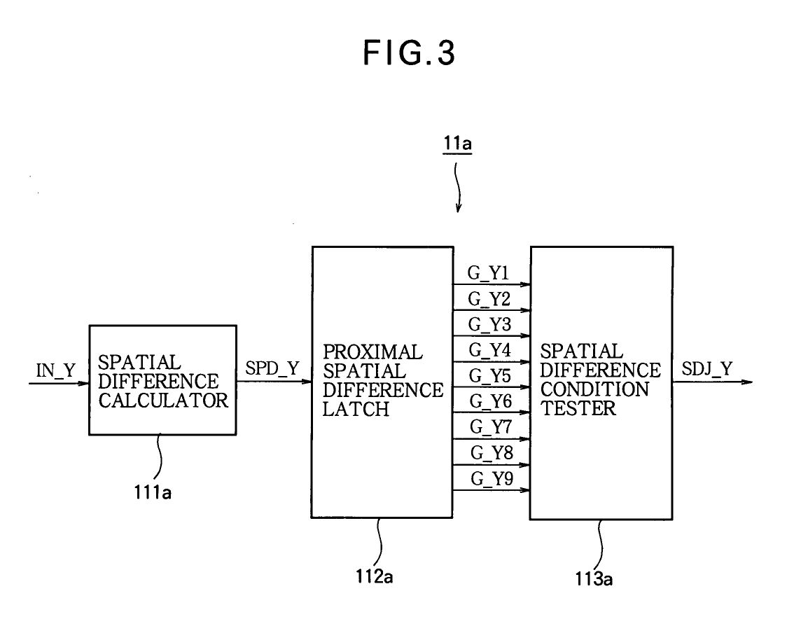

An example of the spatial difference comparator 11a in FIG. 2 is shown in FIG. 3. The spatial difference comparator 11a comprises a spatial difference calculator 111a, a proximal spatial difference latch 112a, and a spatial difference condition tester 113a.

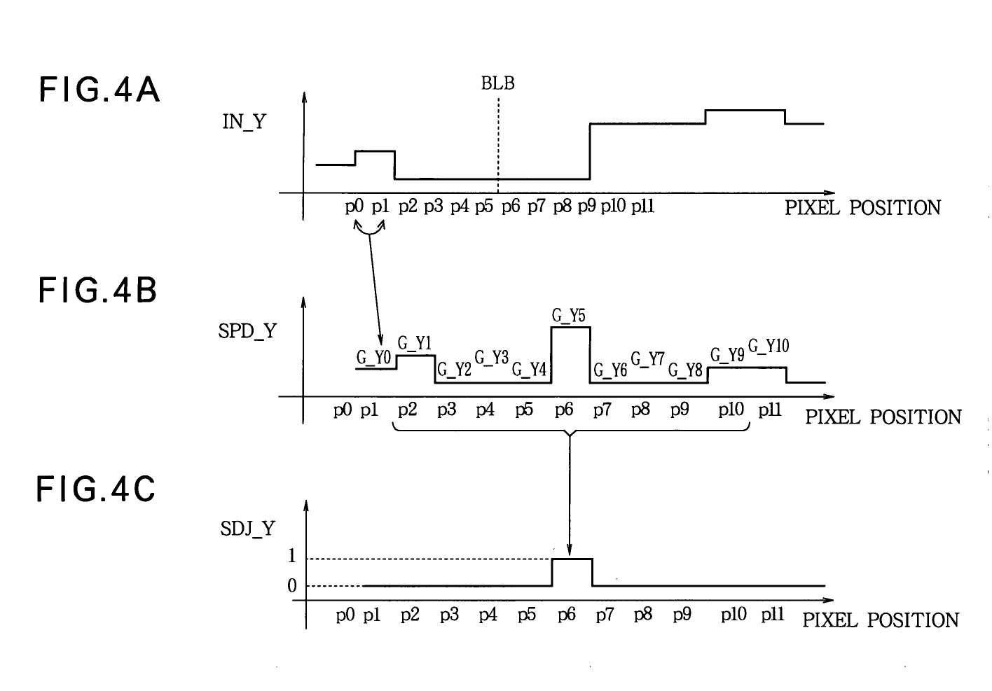

The spatial difference calculator 111a calculates the absolute values of the gray scale differences between the values of adjacent pixels in the input luminance signal IN_Y, and outputs the gray scale differences as a spatial difference signal SPD_Y to the proximal spatial difference latch 112a. For example, given an input luminance signal IN_Y with the gray scale distribution shown in FIG. 4A, including a block boundary BLB, the spatial difference calculator 111a calculates the absolute value G_Y0 of the gray scale difference between the values of adjacent pixels p0 and p1 as shown in FIG. 4B, and outputs the calculated gray scale difference as a spatial difference. The spatial difference calculator 111a similarly calculates the absolute values G_Y1 to G_Y10 of the gray scale differences between the values of the other adjacent pixels p1 to p11.

The proximal spatial difference latch 112a holds the received spatial difference signal SPD_Y in a plurality of flip-flop circuits, and outputs the nine adjacent spatial differences G_Y1 to G_Y9 to the spatial difference condition tester 113a.

When the spatial difference condition tester 113a receives the nine adjacent spatial differences G_Y1 to G_Y9, if the fifth spatial difference G_Y5 is the greatest among the first to fifth spatial differences G_Y1 to G_Y5, or among the fifth to ninth spatial difference G_Y5 to G_Y9, the spatial difference condition tester 113a outputs a decision signal SDJ_Y with the value ‘1’. If this condition is not satisfied, the spatial difference condition tester 113a outputs the decision signal SDJ_Y with the value ‘0’. For example, since in the spatial difference signal SPD_Y shown in FIG. 4B, the spatial differences G_Y1 to G_Y9 satisfy both conditions (1) and (2) below, the spatial difference condition tester 113a outputs the value ‘1’ as a decision signal SDJ_Y.

G_{—}Y5>MAX(G_{—}Y1,G_{—}Y2,G_{—}Y3,G_{—}Y4) (1)

G_{—}Y5>MAX(G_{—}Y6,G_{—}Y7,G_{—}Y8,G_{—}Y9) (2)

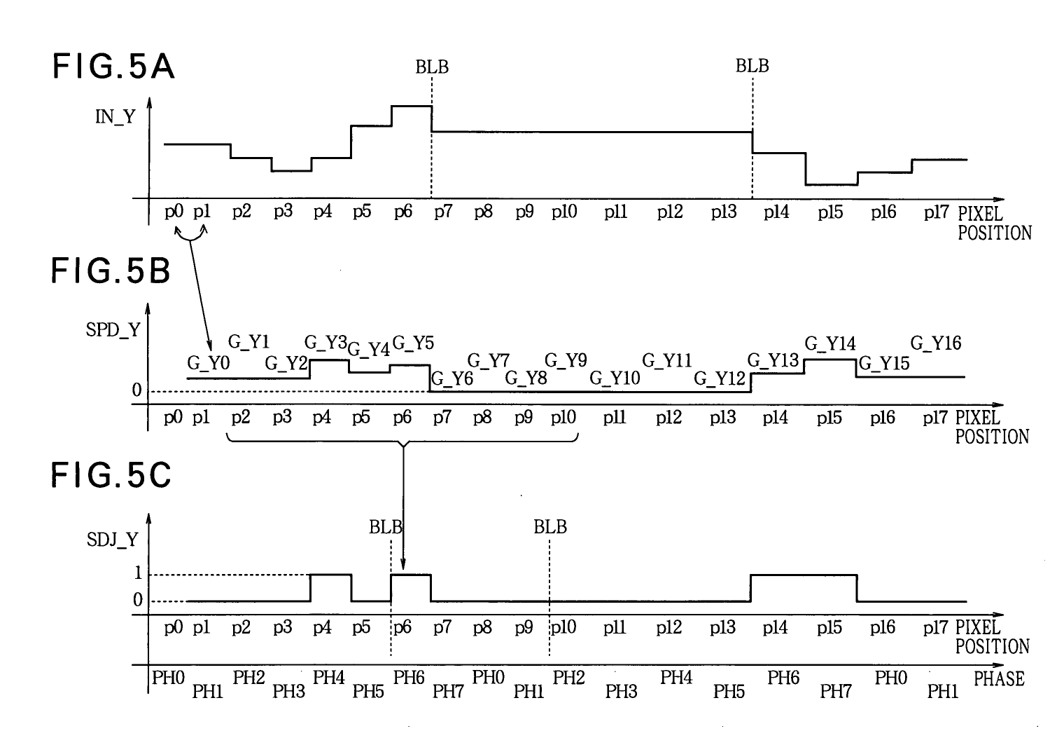

Similarly, if the spatial difference calculator 111a receives the input luminance signal IN_Y shown in FIG. 5A, the spatial difference calculator 111a outputs the spatial difference signal SPD_Y as shown in FIG. 5B. When the spatial difference condition tester 113a receives the spatial differences G_Y1 to G_Y9 shown in FIG. 5B, the spatial difference condition tester 113a asserts the decision signal SDJ_Y as shown in FIG. 5C. In the spatial difference signal SPD_Y shown in FIG. 5B, spatial differences G_Y1 to G_Y9 do not satisfy condition (1), but they satisfy condition (2), so the spatial difference condition tester 113a outputs ‘1’ as the value of the decision signal SDJ_Y as shown in FIG. 5C.

In FIG. 5C, although the decision signal SDJ_Y is ‘1’ in pixel positions p6 and p14 at the phase PH6 at which the block boundaries BLB occur, the decision signal SDJ_Y is also ‘1’ in pixel positions p4 and p15 at phases PH4 and PH7, at which block boundaries BLB do not occur. The decision signal SDJ_Y is always ‘1’ in the pixel positions at phase PH6, however, whereas the decision signal SDJ_Y is sometimes ‘1’ but more often ‘0’ in pixel positions at the phases other than phase PH6. Accordingly, the phased accumulator 12a outputs the maximum count value among the eight count values CAV_Y0 to CAV_Y7 at phase PH6 at which block boundaries BLB occur.

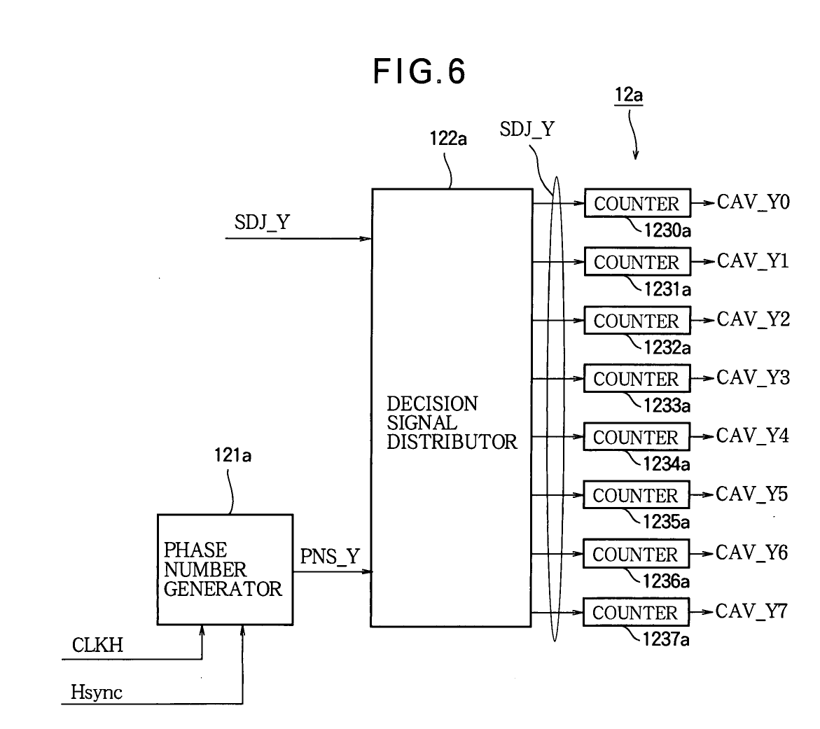

An example of the phased accumulator 12a in FIG. 2 is shown in FIG. 6. The phased accumulator 12a comprises a phase number generator 121a, a decision signal distributor 122a, and eight counters 1230a-1237a.

The phase number generator 121a operates in synchronization with the horizontal synchronizing signal Hsync, detects phases by counting pixel clocks CLKH, and outputs a phase number signal PNS_Y with phase values from PH0 to PH7 to the decision signal distributor 122a to identify the phases.

For example, the phase number generator 121a may set a particular phase, such as phase PH0, when it receives the horizontal synchronizing signal Hsync, and then increment the phase value (number) by one at each cycle of the pixel clock CLKH. When the phase number reaches the maximum value PH7, the phase number generator 121a resets the phase number at the initial value PH0 and then repeats the same process.

The decision signal distributor 122a routes the input decision signal SDJ_Y to different counters 1230a-1237a according to the phase indicated by the input phase number signals PNS_Y. More specifically, if a phase number signal PNS_Y indicates a certain phase PHn, n being a positive integer equal to or greater than zero and equal to or less than seven (0≦n≦7), the decision signal distributor 122a outputs the decision signal SDJ_Y received at phase PHn to the corresponding counter 123na.

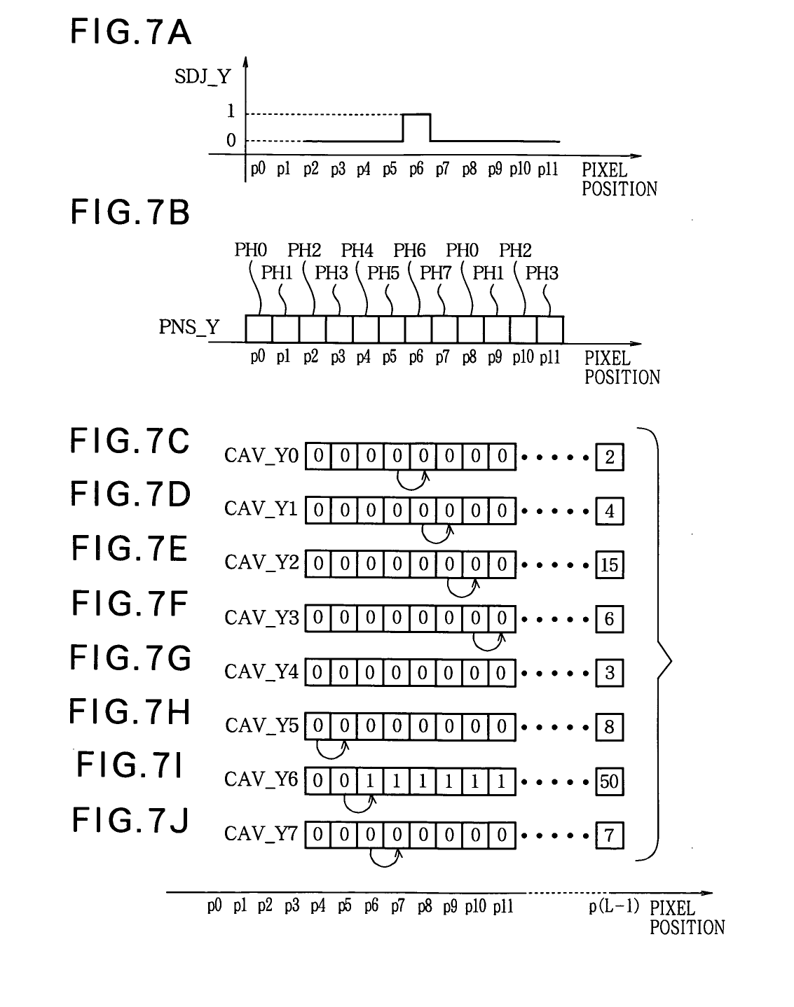

If, for example, the decision signal distributor 122a receives the decision signal SDJ_Y shown in FIG. 7A and the phase number signals PNS_Y shown in FIG. 7B, since the decision signal SDJ_Y is ‘1’ at pixel position p6, and the phase number signal PNS_Y indicates the phase PH6 in pixel position p6, the decision signal distributor 122a outputs the ‘1’ value of the decision signal SDJ_Y to the counter 1236a that produces count value CAV_Y6 as shown in FIG. 7I.

Counters 1230a-1237a receive the decision signal SDJ_Y through the decision signal distributor 122a, count the input values, and output count values CAV_Y0 to CAV_Y7 for one line at a timing synchronized with the horizontal synchronizing signal Hsync.

If, for example, one line has L pixels, L being a positive integer, the counters 1230a-1237a output the count values CAV_Y0 to CAV_Y7 reached at the (L−1)th pixel position p(L−1) as shown in FIGS. 7C to 7J.

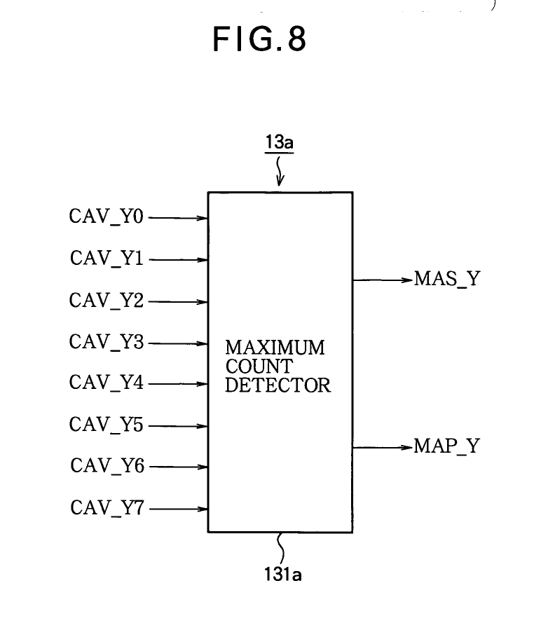

An example of the maximum sum and phase detector 13a in FIG. 2 is shown in FIG. 8. The maximum sum and phase detector 13a includes a maximum count detector 131a.

For each line, the maximum count detector 131a compares the eight input count values CAV_Y0 to CAV_Y7, finds a maximum value CAV_Ym among the eight count values, and outputs a maximum phase signal MAP_Y indicating a phase PHm at which the maximum value CAV_Ym occurs. In some embodiments the maximum count detector 131a also outputs a maximum value signal MAS_Y as shown, indicating the maximum value CAV_Ym, but the maximum value signal MAS_Y is not used in the present embodiment.

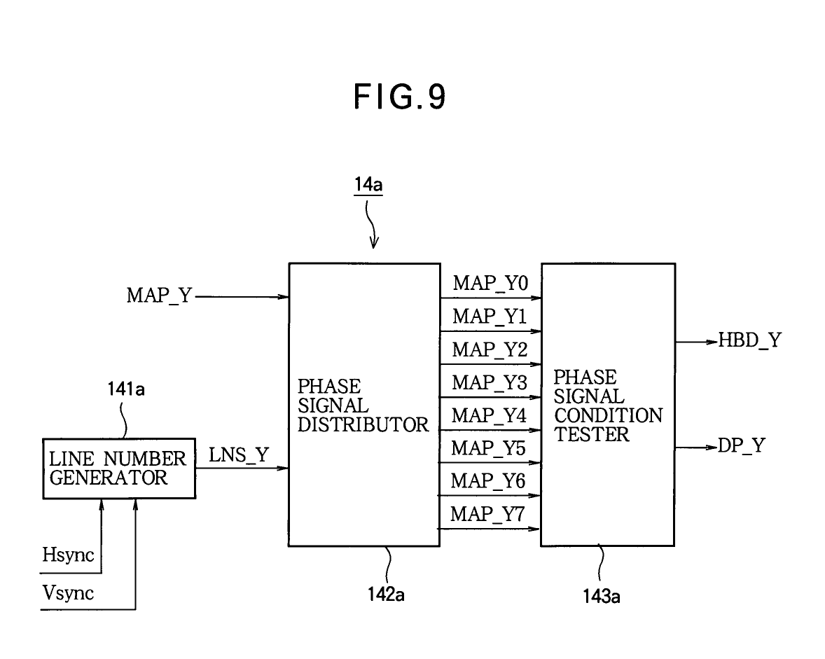

An example of the internal structure of the phase consistency tester 14a in FIG. 2 is shown in FIG. 9. The phase consistency tester 14a comprises a line number generator 141a, a phase signal distributor 142a, and a phase signal condition tester 143a.

The line number generator 141a operates in synchronization with the vertical synchronizing signal Vsync, counts lines by counting horizontal synchronizing signals Hsync modulo eight, and outputs a line number signal LNS_Y with line values from PV0 to PV7 to the phase signal distributor 142a to identify the lines.

The phase signal distributor 142a supplies the input maximum phase signal MAP_Y to the phase signal condition tester 143a as line-MAP_Y values MAP_Y0 to MAP_Y7 according to the lines PV0 to PV7 indicated by the input line number signals LNS_Y. More specifically, if the line number signal LNS_Y indicates a certain line PVn, n being an integer from zero to seven (0≦n≦7), the phase signal distributor 142a outputs the maximum phase signal MAP_Yn received at line PVn as line-MAP_Y value MAP_Yn.

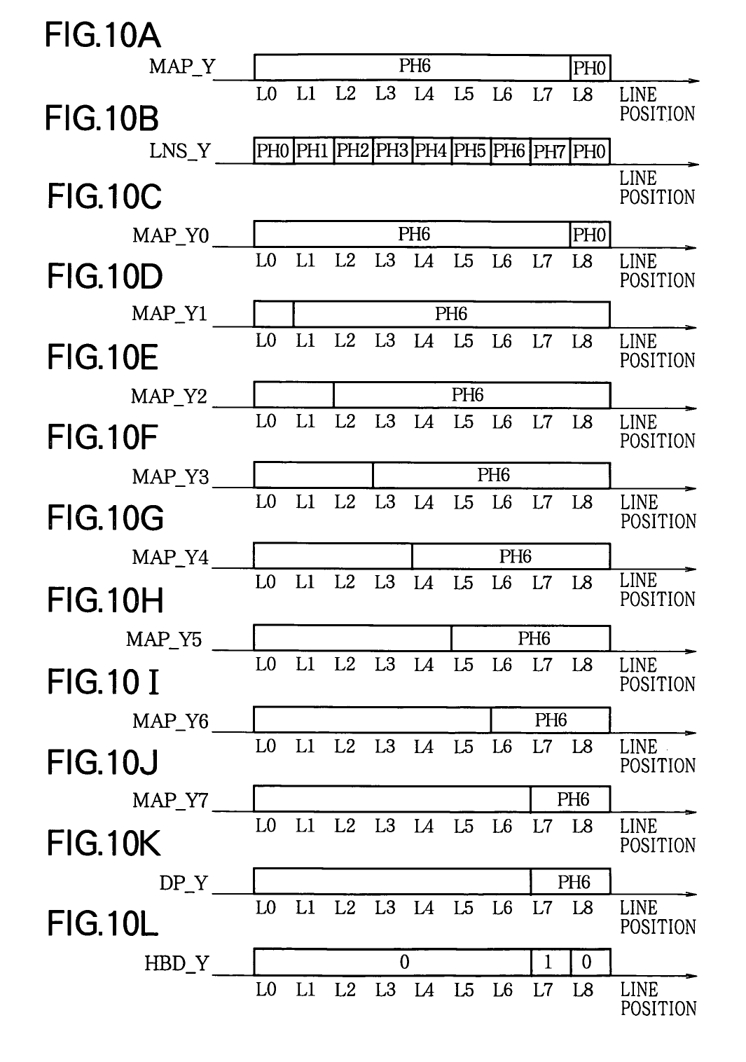

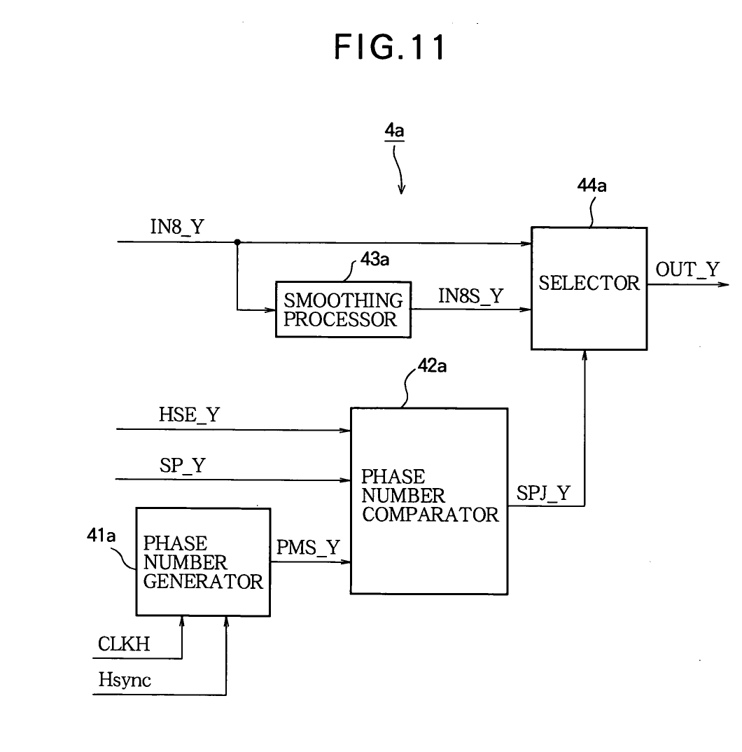

If, for example, the phase signal distributor 142a receives the maximum phase signal MAP_Y as shown in FIG. 11A and the line number signal LNS_Y as shown in FIG. 10B, then for line LO0 since the maximum phase signal MAP_Y is ‘PH6’ and the line number signal LNS_Y indicates line PV0, the phase signal distributor 142a outputs a line-MAP_Y value MAP_Y0 of ‘PH6’ as shown in FIG. 10C.

The phase signal condition tester 143a compares the input values MAP_Y0 to MAP_Y7. If all eight line-MAP_Y values MAP_Y0 to MAP_Y7 are identical, the phase signal condition tester 143a outputs a horizontal boundary detection signal HBD_Y with the value ‘1’ as shown in FIG. 10L, and a detected phase signal DP_Y with a value equal to the identical line-MAP_Y values MAP_Y0 to MAP_Y7 as shown in FIG. 10K. If all eight line-MAP_Y values MAP_Y0 to MAP_Y7 are not identical, the phase signal condition tester 143a outputs the horizontal boundary detection signal HBD_Y with the value ‘0’ as shown in FIG. 10L.

In the operation shown in FIGS. 10A to 10L, for example, at line L7, since the line-MAP_Y values MAP_Y0 to MAP_Y7 are identically ‘PH6’ for lines PV0 to PV7, the phase signal condition tester 143a outputs a detected phase signal DP_Y with the value ‘PH6’, and a horizontal boundary detection signal HBD_Y with the value ‘1’. The phase signal condition tester 143a continues to output the detected phase signal DP_Y with this value (‘PH6’ in this example) either until the end of the video field or frame or until the line-MAP_Y values MAP_Y0 to MAP_Y7 for lines PV0 to PV7 all have another identical value (other than ‘PH6’).

In the example shown in FIGS. 10A to 10L, since line-MAP_Y value MAP_Y0 becomes ‘PH0’ in the next line L8 after line L7, the condition that the maximum phase signal MAP_Y must have identical line-MAP_Y values MAP Y0 to MAP Y7 is no longer satisfied, but the phase signal condition tester 143a continues to output the detected phase signal DP_Y with the value ‘PH6’ until the end of the video field, or until at some point the line-MAP_Y values MAP_Y0 to MAP_Y7 all become identically equal to a value other than ‘PH6’. If, for example, at some point the line-MAP_Y values MAP_Y0 to MAP_Y7 of lines PV0 to PV7 are all ‘PH2’, the phase signal condition tester 143a then switches from output of ‘PH2’ to output of ‘PH2’ as the detected phase signal DP_Y.

Of the three detected phase signals DP_Y, DP_Cb, DP_Cr, the block phase comparator 2 compares the phase values of those signals accompanied by a horizontal boundary detection signal indicating that block boundaries were detected. If the compared phase values all match, the block phase comparator 2 outputs the detected phase signals DP_Y, DP_Cb, DP_Cr as smoothing phase signals SP_Y, SP_Cb, SP_Cr.

The block phase comparator 2 may output the horizontal boundary detection signals HBD_Y, HBD_Cb, HBD_Cr as horizontal smoothing enable signals HSE_Y, HSE_Cb, HSE_Cr. The horizontal smoother 4 then smoothes each signal component when its horizontal boundary detection signal is ‘1’; that is, the horizontal smoother 4 reduces block noise selectively by smoothing only those signal components in which block boundaries are detected. One effect of this arrangement is to reduce color block noise caused in sky and sunset scenes having little change in luminance.

Alternatively, the block phase comparator 2 may output all three detected phase signals DP_Y, DP_Cb, DP_Cr as smoothing phase signals SP_Y, SP_Cb, SP_Cr and set all three horizontal smoothing enable signals HSE_Y, HSE_Cb, HSE_Cr at ‘1’ whenever the luminance horizontal boundary detection signal HBD_Y is ‘1’ and the detected phase values of all signal components in which block boundaries are detected match. If this scheme is used, then whenever a block boundary is detected in the luminance signal component, if all detected block boundaries having matching phase values, the horizontal smoother 4 smoothes all three signal components, so besides reducing luminance block noise, to which human vision is particularly sensitive, the horizontal smoother 4 can reduce color block noise that could not be adequately detected in the color difference signals.

In another alternative scheme, whenever at least two of the horizontal boundary detection signals HBD_Y, HBD_Cb, HBD_Cr are ‘1’, the block phase comparator 2 outputs the detected phase signals DP_Y, DP_Cb, DP_Cr as smoothing phase signals SP_Y, SP_Cb, SP_Cr, regardless of whether the phases match or not, and sets the horizontal boundary detection signals HBD_Y, HBD_Cb, HBD_Cr as the horizontal smoothing enable signals HSE_Y, HSE_Cb, HSE_Cr. That is, when block boundaries are detected in two or more signal components, the horizontal smoother 4 reduces block noise by smoothing all those signal components in which block boundaries are detected. This arrangement reduces block noise even when the periodic location of the block boundaries is uncertain, and because each signal component is smoothed according to its own detected phase signal and horizontal boundary detection signal, the circuit size can be reduced.

In yet another scheme, whenever the luminance horizontal boundary detection signal HBD_Y and at least one of the color horizontal boundary detection signals HBD_Cb, HBD_Cr are ‘1’, the block phase comparator 2 outputs the detected phase signals DP_Y, DP_Cb, DP_Cr as smoothing phase signals SP_Y, SP_Cb, SP_Cr, regardless of whether the phases match or not, and sets the horizontal boundary detection signals HBD_Y, HBD_Cb, HBD_Cr as the horizontal smoothing enable signals HSE_Y, HSE_Cb, HSE_Cr. The horizontal smoother 4 accordingly reduces block noise by smoothing all those signal components in which block boundaries are detected, provided block boundaries are detected in the luminance component and at least one other component. This arrangement enables the horizontal smoother 4 to reduce luminance block noise, to which human vision is particularly sensitive, even if the location of the block boundaries is uncertain.

In still another scheme, if the horizontal boundary detection signals HBD_Y, HBD_Cb, HBD_Cr all are ‘1’ and at least two of the detected phase signals DP_Y, DP_Cb, DP_Cr match, the block phase comparator 2 outputs the matching phase as the value of all three smoothing phase signals SP_Y, SP_Cb, SP_Cr, and sets all the horizontal smoothing enable signals HSE_Y, HSE_Cb, HSE_Cr to ‘1’. That is, when block boundaries were detected in all three signal components, the horizontal smoother 4 all signal components at periodic locations determined by a majority voting rule. This arrangement enables the horizontal smoother 4 to reduce block noise in all signal components consistently even if block boundaries are not detected at identical phases in all signal components.

The block phase comparator 2 can operate by similar schemes when there are only two signal components, or when there are four or more signal components, instead of the three components assumed in the description above. In general there may be k detected phase signals DP_*, horizontal boundary detection signals HBD_*, smoothing phase signals SP_*, and horizontal smoothing enable signals HSE_*, where the asterisk symbol (*) indicates Y, Cb, Cr or any other signal component. If k is equal to or greater than four (k≧4), then in the majority voting scheme, the block phase comparator 2 selects a phase indicating a periodic location at which block boundaries were detected in the greatest number of the signal components, and outputs this phase as the sampling phase for all signal components.

Next, the operation of the eight-line memory 3 and horizontal smoother 4 will be described.

The eight-line luminance memory 3a stores eight lines of the input luminance signal IN_Y, and outputs the stored signal as an input luminance signal IN8_Y to the luminance horizontal smoother 4a with an eight-line delay.

Similarly, the eight-line blue color difference memory 3b stores eight lines of the input blue color difference signal IN_Cb, and outputs the stored signal as an input blue color difference signal IN8_Cb to the blue color difference horizontal smoother 4b with an eight-line delay.

The eight-line red color difference memory 3c likewise stores eight lines of the input red color difference signal IN_Cr, and outputs the stored signal as an input red color difference signal INB_Cr to the red color difference horizontal smoother 4c with an eight-line delay.

The luminance horizontal smoother 4a smoothes the input luminance signal IN8_Y at the locations indicated by the smoothing phase signal SP_Y in the current line, and outputs the resulting partially smoothed signal as an output luminance signal OUT_Y.

The blue color difference horizontal smoother 4b has the same internal structure as the luminance horizontal smoother 4a, smoothes the input blue color difference signal IN8_Cb at the locations indicated by the smoothing phase signal SP_Cb in the current line, and outputs the resulting partially smoothed signal as an output color difference signal OUT_Cb.

The red color difference horizontal smoother 4c also has the same internal structure as the luminance horizontal smoother 4a, smoothes the input red color difference signal IN8_Cr at the locations indicated by the smoothing phase signal SP_Cr in the current line, and outputs the resulting partly smoothed signal as an output color difference signal OUT_Cr.

An example of the internal structure of the luminance horizontal smoother 4a in FIG. 1 is shown in FIG. 11. The luminance horizontal smoother 4a in this example comprises a phase number generator 41a, a phase number comparator 42a, a smoothing processor 43a, and a selector 44a.

The phase number generator 41a has the same structure as the phase number generator 121a shown in FIG. 6. The phase number generator 41a receives the horizontal synchronizing signal Hsync and pixel clock signal CLKH, operates in synchronization with the horizontal synchronizing signal Hsync, detects phases by counting pixel clock (CLKH) cycles, and outputs a phase number signal PMS_Y with phase values from PH0 to PH7 to the phase number comparator 42a to identify phases.

The phase number comparator 42a compares the input phase number signal PMS_Y with the input smoothing phase signal SP_Y, and outputs a four-phase range decision signal SPJ_Y to the selector 44a according to the result. If the smoothing phase signal SP_Y indicates a certain phase PHn, n being an integer equal to or greater than zero and equal to or less than seven (0≦n≦7), and the phase number signal PMS_Y indicates phase PH(n−2), PH(n−1), PHn, or PH(n+1), modulo eight, the phase number comparator 42a outputs the range decision signal SPJ_Y with the value ‘1’. If this condition is not satisfied, the phase number comparator 42a outputs the range decision signal SPJ_Y with the value ‘0’.

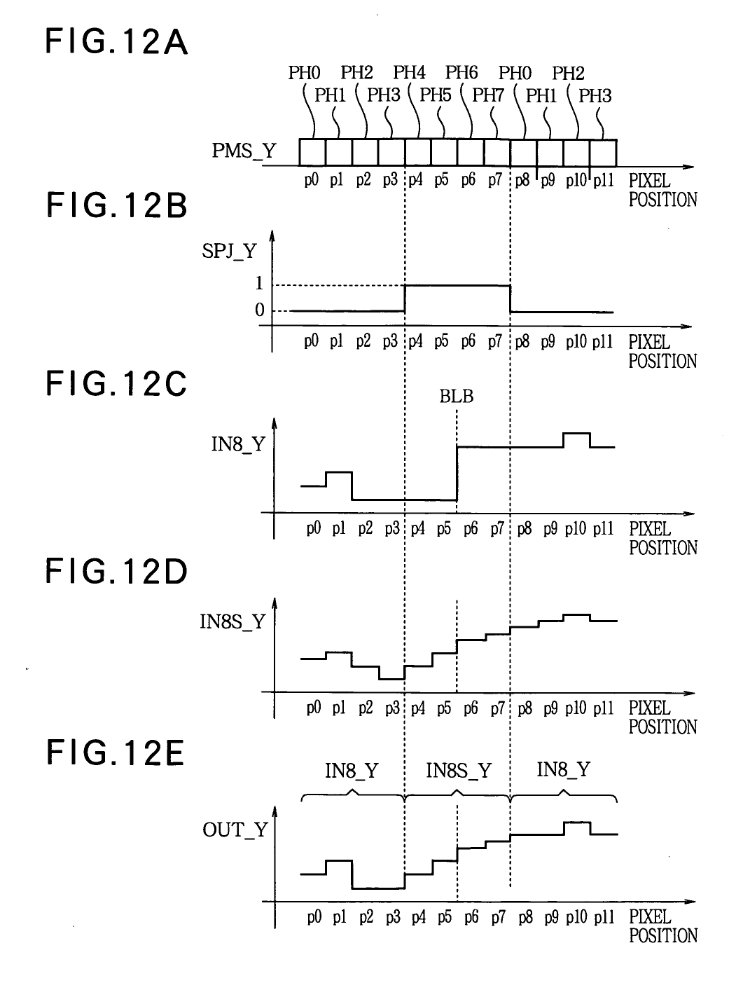

If, for example, the phase number comparator 42a receives the phase number signal PMS_Y shown in FIG. 12A and the smoothing phase signal SP_Y indicates phase PH6 (n=6), since the phase values indicated by the phase number signal PMS_Y at pixel positions p4 to p7 are PH4 to PH7, which are equal to PH(n−2), PH(n−1), PHn, and PH(n+1), the phase number comparator 42a gives the range decision signal SPJ_Y the value ‘1’ at pixel positions p4 to p7, and the value ‘0’ at pixel positions other than pixel positions p4 to p7.

The smoothing processor 43a smoothes the input luminance signal INB_Y to generate a smoothed signal IN8S_Y, and outputs the smoothed signal IN8S_Y to the selector 44a.

If, for example, the smoothing processor 43a receives an input luminance signal IN8_Y in which a block boundary BLB occurs as shown in FIG. 12C, the smoothing processor 43a smoothes the input luminance signal IN8_Y and outputs the smoothed signal IN8S_Y as shown in FIG. 12D.

The selector 44a selects the input smoothed signal IN8S_Y or the input luminance signal IN8_Y according to the input decision signal SPJ_Y, and outputs the output luminance signal OUT_Y as shown in FIG. 12E. More specifically, when the decision signal SPJ_Y is ‘1’, the selector 44a selects the smoothed signal IN8S_Y, and outputs the smoothed signal IN8S_Y as the output luminance signal OUT_Y. When the decision signal SPJ_Y is ‘0’, the selector 44a selects the luminance signal IN8_Y, and outputs the luminance signal IN8_Y as the output luminance signal OUT_Y as shown in FIG. 12E.

In the operation shown in FIGS. 12A to 12E, for example, since the decision signal SPJ_Y is ‘1’ in pixel positions p4 to p7 as shown in FIG. 12B, the smoothed signal INBS_Y shown in FIG. 12D is output as the output luminance signal OUT_Y in these pixel positions as shown in FIG. 12E, and since the decision signal SPJ_Y is ‘0’ in pixel positions other than pixel positions p4 to p7, the input luminance signal INB_Y shown in FIG. 12C is output as the output luminance signal OUT_Y in the pixel positions other than pixel positions p4 to p7.

As described above, the present embodiment detects block boundaries in the luminance signal and color difference signals, and smoothes the luminance signal and the color difference signals according to detection results indicating whether block boundaries were detected in each signal, and the phase at which the block boundaries were detected. The present embodiment can therefore remove block noise from scenes with gradual changes in color but little or no change in luminance, a type of block noise that known block noise reducers fail to remove.

The phased accumulator 12a in the luminance horizontal block boundary detector 1a includes eight counters 1230a-1237a, matching the horizontal block width of eight pixels in the description above. In general, if the horizontal block width is assumed or known to be N pixels, where N may be any integer greater than one, the block noise reducer includes N counters (that operate in the same way as counters 1230a-1237a), and the phase number signals PNS_Y and PMS_Y take values from zero to N−1.

The present embodiment is not restricted to requiring eight identical line-MAP_Y values MAP_Y0 to MAP_Y7 as in the description above. The required number of consecutive line-MAP_Y values may be any number equal to or greater than two. The more line-MAP_Y values are used, the more effectively the luminance horizontal block boundary detector 1a can detect block noise, but the detection operation takes longer and requires more hardware, so the optimum number of required identical line-MAP_Y values is a design choice to be made in consideration of speed, accuracy, and hardware size and cost.

Instead of including a luminance signal component, a blue color difference signal component, and a red color difference signal component as in the description above, the input video signal may include, for example, a red primary color component, a green primary color component, and a blue primary color component. Alternatively, the input video signal may include four or more primary color components. More generally, the input video signal may have any number of components equal to or greater than two.

Those skilled in the art will recognize that further variations are possible within the scope of the invention, which is defined in the appended claims.

What is claimed is:

1. A block noise reducer that receives an input video signal including a plurality of signal components, comprising:
a plurality of block noise detectors for detecting block boundaries in respective signal components of the input video signal and outputting respective boundary detection signals indicating whether block boundaries are detected and respective detected phase signals indicating periodic locations of the detected block boundaries;
a block phase comparator for generating smoothing enable signals indicating whether to smooth each of the signal components of the input video signal and smoothing phase signals indicating periodic locations in each of the signal components of the input video signal, based on the boundary detection signals and detected phase signals output by the plurality of block noise detectors; and
a smoother for smoothing the signal components indicated by the smoothing enable signals at the periodic locations indicated by the smoothing phase signals.

2. The block noise reducer of claim 1, wherein if the boundary detection signals indicate that block boundaries are detected in at least one of the signal components and the detected phase signals indicate identical periodic locations for all of the detected block boundaries, the block phase comparator outputs smoothing enable signals enabling smoothing of the signal components in which the block boundaries were detected and outputs, for all of the signal components in which the block boundaries were detected, smoothing phase signals identical to the detected phase signals of the signal components in which the block boundaries were detected.

3. The block noise reducer of claim 1, wherein one of the signal components of the input video signal is a luminance signal component, and if the block detection signals indicate that block boundaries are detected in at least the luminance signal component and the detected phase signals indicate identical periodic locations for all of the detected block boundaries, the block phase comparator outputs smoothing enable signals enabling smoothing of all of the signal components and outputs, for all of the signal components, smoothing phase signals identical to the detected phase signal of the luminance signal component.

4. The block noise reducer of claim 1, wherein if the boundary detection signals indicate that block boundaries are detected in at least two of the signal components, the block phase comparator outputs smoothing enable signals enabling smoothing of the signal components in which the block boundaries were detected and outputs smoothing phase signals identical to the detected phase signals of the signal components in which the block boundaries were detected.

5. The block noise reducer of claim 1, wherein one of the signal components of the input video signal is a luminance signal component, and if the block detection signals indicate that block boundaries are detected in the luminance signal component and at least another one of the signal components, the block phase comparator outputs smoothing enable signals enabling smoothing of all of the signal components in which the block boundaries were detected and outputs, for all of the signal components in which the block boundaries were detected, smoothing phase signals identical to the detected phase signal of the luminance signal component.

6. The block noise reducer of claim 1, wherein if the boundary detection signals indicate that block boundaries are detected in all of the signal components, the block phase comparator outputs smoothing enable signals enabling smoothing of all of the signal components and outputs smoothing phase signals indicating a periodic location at which the block boundaries were detected in a greatest number of the signal components.
